(19) United States
(12) Patent Application Publication
(10) Pub. No.: US 2015/0371284 A1
(43) Pub. Date: Dec. 24, 2015

(54) METHOD FOR PROMOTING PLATFORM BASED ON USER BEHAVIOR ANALYSIS

(71) Applicant: Beijing Jinher Software Co., Ltd, Beijing (CN)

(72) Inventor: Runfeng LUAN, Beijing (CN)

(21) Appl. No.: 14/324,254

(22) Filed: Jul. 7, 2014

(30) Foreign Application Priority Data
Jun. 23, 2014 (CN) 201410284169.4

(51) Int. Cl. G06Q 30/02

(52) U.S. Cl. CPC G06Q 30/0274; G06Q 30/0214; G06Q 30/0246

(57) ABSTRACT

The invention discloses a method for promoting a platform based on user behavior analysis. A promotion platform comprises a self-service factory sharing and planning module, a producing and making module, and a promotion information statistical module. By means of the self-service factory sharing and planning module, a user applies for and obtains by self-service a personalized promotion code to become a promoter, the promoter shares the obtained personalized promotion code in the form of a hyperlink or a two-dimensional code with personalized icon on a third party network platform by means of a one-touch sharing module, the user enters the producing and making module of the promotion platform by clicking the hyperlink or scanning the two-dimensional code with personalized icon.

### CROSS-REFERENCE TO RELATED APPLICATION

This application claims the priority benefit of Chinese patent application No.201410284169.4, filed on Jun. 23, 2014. The entirety of the above-mentioned patent application is hereby incorporated by reference herein and made a part of specification.

### BACKGROUND OF THE INVENTION

1. Field of the Invention

The invention relates to the field of sharing, and particularly to a method for promoting a platform based on user behavior analysis.

2. Background of the Invention

Currently, with the rapid development of smart mobile terminals, applications which can be installed on smart mobile terminals are experiencing a rapid growth. The application is a programming language used for realizing some functions, and is a collection of programs complied by the programming language. According to the use of application, the applications can be classified into entertainment, games, books, life, utilities, social networking applications, or the like. The concern of the application developers and/or application store service providers lies in that how to inform users of the presence of these applications.

“Word of mouth” is a good manner for informing users of the presence of these applications. The so-called “word of mouth” refers to the communication and sharing between users. In the current case that Internet is very popular, a user can share an excellent application in his opinion with his friends or other users through a server which provides social network service (SNS) or forum function. In this process of sharing, the website or two-dimensional code with personalized icon of the application is directly pasted other third party network platforms for users to exchange and share. However, the effect of sharing is not subject to systematic statistical analysis, and yet can not be used as a mature promotion mode for the application developer and/or application store service provider. In view of this, the invention establishes a promotion platform, and encourages the promoter to use the promotion platform by sharing revenue, so that more users will log in the producing and making module to create personalized applications, thus effectively promoting the application store service provider.

### BRIEF SUMMARY OF THE INVENTION

It is an object of the invention to overcome the drawback in the prior art by providing a method for promoting a platform based on user behavior analysis. In this method, a promotion platform is established, and the promoter is encouraged to use the promotion platform by sharing revenue, so that more users will log in the producing and making module to create personalized applications. In particular, the user can quickly create a promotion code in the promotion platform by self-service, and can quickly establish a two-dimensional code with personalized icon based on the promotion code, thus facilitating one-touch sharing for the promoter. The promotion platform further binds the promotion code information with the user information, enabling the promotion information platform to track and summarize in real-time. The promotion platform further provides a promotion effect statistical analysis, facilitating the promoter to track in real-time promotion details of the promotion code. Such details comprise the amount of applications (APPs), amount of news releases, monthly amount of active users (MAU), and revenue of the promoter.

To solve the above problem, the invention discloses a method for promoting a platform based on user behavior analysis, characterized by comprising:

a promotion platform, which comprises a self-service factory sharing and planning module, a producing and making module, and a promotion information statistical module;

by means of the self-service factory sharing and planning module, a user applies for and obtains by self-service a personalized promotion code to become a promoter, the promoter shares the obtained personalized promotion code in the form of a hyperlink or a two-dimensional code with personalized icon on a third party network platform by means of a one-touch sharing module, the user enters the producing and making module of the promotion platform by clicking the hyperlink or scanning the two-dimensional code with personalized icon;

a promotion platform server monitors the user who has logged in the promotion platform, tracks and records behavior of the user who has logged in the promotion platform, makes statistics on the user behavior and the corresponding user behavior data, and presents the statistical result on the promotion information statistical platform.

Preferably, the promotion platform further comprises a user account management module,

upon detecting that the user who has logged in the promotion platform, the promotion platform server automatically tracks the path of the logged-in user to obtain the personalized promotion code which has been shared on the third party network platform, retrieves from the promotion platform server by using the obtained personalized promotion code the personal information of the promoter which is bound with the obtained personalized promotion code, collects the behavior of the user who has logged in the promotion platform from the same promoter and the corresponding user behavior data into the promotion information statistical platform of the promoter, converts and updates the obtained revenue into the account management module.

Preferably, the user behavior comprises when and where the user logs in the promotion platform and the operations the user makes in the promotion platform,

said operations comprise registering to enter the producing and making module, finishing the producing and making process of a product, entering the self-service factory sharing and planning module to apply for a personalized promotion code, and downloading any other personalized application,

if any of said operations is detected, the promotion platform server updates the user behavior data.

Preferably, the self-service factory sharing and planning module makes an statistical analysis on the user behavior, makes statistics on monthly amount of active users, amount of the personalized applications finished by users, and amount of news releases in the finished personalized application, which correspond to the personalized promotion code of the promoter, updates the statistical result into the promotion information platform, converts and updates the obtained revenue into the account management module.

Preferably, when the user applies for the personalized promotion code through the self-service factory sharing and planning module, the user firstly enters the account management module and inputs the user's personal information, and the promotion platform server automatically binds the user's personal information with the personalized promotion code.

Preferably, the personalized promotion code comprises the website of the promotion platform and the personal information of the promoter.

Preferably, the producing and making module is a personalized application making background in which the user makes the personalized application.

Preferably, the producing and making module tracks the origin of the user in the third party network platform who clicks the personalized promotion code to obtain the related information of the third party network platform, makes statistics and synchronously updates the statistical data into the promotion information module.

Preferably, the related information of the third party network platform comprises the name and website of the third party network platform and the amount of other users from the same third party network platform.

Preferably, the promotion information statistical module automatically ranks and presents the change in click rate of the promotion code of promoter from most to least.

Preferably, the promoter personal account is settled once per month at an appointed day.

Preferably, the promoter registers the promotion platform before applying for the personalized promotion code through the self-service factory sharing and planning module,

the promoter logs in the promotion platform and selects to make a personalized application,

upon finishing the personalized application, the promoter obtains a two-dimensional code with personalized icon,

the promoter shares the two-dimensional code with personalized icon in the third party network platform by one-touch sharing, and

the user scans the two-dimensional code with personalized icon and logs in the producing and making module to download the personalized application.

Preferably, after the user scans the two-dimensional code with personalized icon corresponding to the personalized application and logs in the promotion platform, the promotion platform server tracks the path of the user who scans the two-dimensional code with personalized icon and logs in the promotion platform, so as to obtain the two-dimensional code with personalized icon,

the promotion platform server retrieves the personal information of the promoter who has made the personalized application by using the obtained two-dimensional code with personalized icon, makes statistics on the amount of users who log in the producing and making module and the amount of users who succeed in downloading the personalized application, respectively, and updates the statistical amount of users into the corresponding promoter personal account.

The personalized icon the two-dimensional code with personalized icon is a text with different fonts or a picture.

In the invention, the method for promoting a platform based on user behavior analysis can utilize various electronic devices to advertise for the producing and making module on different third party network platforms or print advertising interfaces by means of the self-service mode for an ordinary user, and can evaluate the advertising effect in a later stage. With the evaluation data, it is further possible to adjust in time the place for advertisements and news releases, thus increasing advertising intensity for the promotion platform and the awareness of the promotion platform. On one hand, the user can quickly create a promotion code in the promotion platform by self-service, and can quickly establish a two-dimensional code with personalized icon based on the promotion code, thus facilitating one-touch sharing for the promoter. The promotion platform further binds the promotion code information with the user information, enabling the promotion information platform to track and summarize in real-time. The promotion platform further provides a promotion effect statistical analysis, facilitating the promoter to track in real-time promotion details of the promotion code. Such details comprise the amount of applications (APPs), amount of news releases, monthly amount of active users (MAU), and revenue of the promoter. On the other hand, an ordinary user can further finish its own personalized application by self-service in the producing and making module. Once the personalized application is finished, the finished personalized application can be pasted on the third party network platform in the form of a two-dimensional code for other users to download. When the other users are downloading the personalized application, they will be brought into the producing and making module, thus indirectly accomplishing the advertising process. At the same time, when the promoter helps to advertise the promotion platform, the producing and making module will make statistics on the promotion amount for each promoter or personalized application producer, and pay the promoter and personalized application producer regularly to increase their initiatives and improving the advertising effect.

### DETAILED DESCRIPTION OF THE EMBODIMENTS

The invention will be described in detail hereinafter by referring to its embodiments, so that the skilled in the art can implement the invention in accordance with the present disclosure.

A method for promoting a platform based on user behavior analysis comprises a promotion platform, which comprises a self-service factory sharing and planning module, a producing and making module, and a promotion information statistical module.

By means of the self-service factory sharing and planning module, a user applies for and obtains by self-service a personalized promotion code to become a promoter, the promoter shares the obtained personalized promotion code in the form of a hyperlink or a two-dimensional code with personalized icon on a third party network platform by means of a one-touch sharing module. The third party network platform can be QQ friends, QQ zone, Sina Weibo, Tencent Weibo, WeChat, SMS, or the like. The user enters the producing and making module of the promotion platform by clicking the hyperlink or scanning the two-dimensional code with personalized icon. The user can set the personalized icon randomly. The personalized icon can be a text with different fonts or a picture. For example, if the personalized application created by the user is entitled “ [symbol] (Encyclopedia for Parenting Knowledge)”, the two-dimensional code can contain a character “ [symbol] ” in red at its central position. The user can change the color and font of the character “ [symbol] ” at his preference.

In the producing and making module, the user signs a cooperation agreement with the promotion platform, and provides his personal information to the producing and making module server. The promotion platform examines the user's personal information. The user who conforms to the corporation requirements of the promotion platform can pass the promotion platform's examination, and is provided a personalized promotion code. At this time, the corporation agreement between the user and the promotion platform goes into effect, and the user becomes a promotion member of the promotion platform. The personalized promotion code obtained by the promotion member comprises the website of the producing and making module and the personal information association code of the promoter. The personal information association code of the promoter can be a user ID. The user ID can be associated with the personal information of the promoter in a database of the producing and making module, e.g., ID card number, age, gender, telephone, email, and occupation.

A promotion platform server monitors the user who has logged in the promotion platform, tracks and records behavior of the user who has logged in the promotion platform, makes statistics on the user behavior and the corresponding user behavior data, and presents the statistical result on the promotion information statistical platform.

The promotion platform further comprises a user account management module. Upon detecting that the user who has logged in the promotion platform, the promotion platform server automatically tracks the path of the logged-in user to obtain the personalized promotion code which has been shared on the third party network platform, retrieves from the promotion platform server by using the obtained personalized promotion code the personal information of the promoter which is bound with the obtained personalized promotion code, collects the behavior of the user who has logged in the promotion platform from the same promoter and the corresponding user behavior data into the promotion information statistical platform of the promoter, converts and updates the obtained revenue into the account management module.

The user behavior comprises when and where the user logs in the promotion platform and the operations the user makes in the promotion platform, and said operations comprise registering to enter the producing and making module, finishing the producing and making process of a product, entering the self-service factory sharing and planning module to apply for a personalized promotion code, and downloading any other personalized application. If any of said operations is detected, the promotion platform server updates the user behavior data.

The self-service factory sharing and planning module makes an statistical analysis on the user behavior, makes statistics on monthly amount of active users, amount of the personalized applications finished by users, and amount of news releases in the finished personalized application, which correspond to the personalized promotion code of the promoter, updates the statistical result into the promotion information platform, converts and updates the obtained revenue into the account management module. For example, in Post-bar of Baidu, Friend Circle of WeChat, or a third party network platform like Weibo, the user see a hyperlink for the personalized promotion code of the promoter, which is accompanied with literal statement like “Do you want your own personalized application? Come to make your own personalized application! Only 1 minute is enough to complete!” If the user is interested, he clicks the hyperlink and enters the producing and making module, thus accomplishing the advertisement for the producing and making module. However, the invention method for promoting a platform based on user behavior analysis differs from the conventional advertising method. Once the user clicks to enter the producing and making module, the producing and making module server will further automatically track the path that the user clicks the hyperlink to enter the producing and making module, and obtains the corresponding personalized promotion code pasted on the third party network platform. By using the personal information association code of the promoter in the obtained personalized promotion code, the producing and making module server finds the personal information of the promoter which is stored in the database, and updates the user data for the user who logs in the producing and making module.

When the user applies for the personalized promotion code through the self-service factory sharing and planning module, the user firstly enters the account management module and inputs the user's personal information, and the promotion platform server automatically binds the user's personal information with the personalized promotion code. When the promoter signs a promotion agreement with the promotion platform in the self-service factory sharing and planning module, he will provide the personal information to the account management module. The promotion platform stores the user's personal information and establishes a corresponding association relationship between the user's personal information and the personalized promotion code. The personal information of the promoter can comprise information like ID card number, age, gender, occupation, or the like. The information not only provide a basis for the producing and making module server to make statistics on users according to the personalized promotion code, but also provide basic information for the producing and making module provide to evaluate the promoter's personal ability. In addition, this information is the basis for sign an agreement and develop a partnership.

The personalized promotion code comprises the website of the promotion platform and the personal information of the promoter.

The producing and making module is a personalized application making background in which the user makes the personalized application.

The producing and making module tracks the origin of the user in the third party network platform who clicks the personalized promotion code to obtain the related information of the third party network platform, makes statistics and synchronously updates the statistical data into the promotion information module.

The related information of the third party network platform comprises the name and website of the third party network platform and the amount of other users from the same third party network platform. The promotion information statistical module automatically ranks and presents the change in click rate of the promotion code of promoter from most to least. The presentation of advertisements will be intensified on the third party network platform with a relatively large amount of users, thus utilizing effectively the network resources.

The promoter personal account is settled once per month at an appointed day.

The promotion information module updates and presents the user behavior data. The promoter can clearly know his promotion outcome and count his revenue. Thus, the principles of transparency and equity are realized. Meanwhile, a hero board can be made to rank revenues of the promoter at a regular interval or the amount of downloads of the personalized application, thus encouraging the promoter and the personalized application producer to promote or improve his personalized application, thus improving promotion effect of the promotion platform.

The promoter registers the promotion platform before applying for the personalized promotion code through the self-service factory sharing and planning module. The promoter logs in the promotion platform and selects to make a personalized application, upon finishing the personalized application. The promoter obtains a two-dimensional code with personalized icon. The promoter shares the two-dimensional code with personalized icon in the third party network platform by one-touch sharing. The user scans the two-dimensional code with personalized icon and logs in the producing and making module to download the personalized application.

After the user scans the two-dimensional code with personalized icon corresponding to the personalized application and logs in the promotion platform, the promotion platform server tracks the path of the user who scans the two-dimensional code with personalized icon and logs in the promotion platform, so as to obtain the two-dimensional code with personalized icon. The promotion platform server retrieves the personal information of the promoter who has made the personalized application by using the obtained two-dimensional code with personalized icon, makes statistics on the amount of users who log in the producing and making module and the amount of users who succeed in downloading the personalized application, respectively, and updates the statistical amount of users into the corresponding promoter personal account.

After the user clicks the personalized promotion code and enters the producing and making module, the producing and making module tracks the origin of the user according to the personalized promotion code, and associates the personal information of the promoter at the same time. The producing and making module retrieves the personal information of the promoter, associates the origin of the user from the third party network platform with the promoter, and makes statistics on the amount of users who log in the promotion platform and who are bought about by the promoter. For instance, when a user with the name of “Cactus” clicks a personalized promotion code of a promoter with the name of “Rosa multiflora” in Sina Weibo and enters the personalized application making platform of the promotion platform, the producing and making module tracks the origin of the user with the name of “Cactus” and determines the origin as Sina Weibo. The producing and making module server records Sina Weibo, and by using the personal information association code contained in the personalized promotion code in Sina Weibo, finds the personal information of the promoter with the name of “Rosa multiflora” in the database, makes statistics and synchronously updates the newly added user with the name of “Cactus” into the personal account of the promoter with the name of “Rosa multiflora” and the database of the promotion platform.

In summary, the invention aims to establish a promotion platform, and encourages the promoter to use the promotion platform by sharing revenue, so that more users will log in the producing and making module to create personalized applications.

Although the invention has been described above with reference to specific embodiments, it should be understood that the limitations of the described embodiments are merely for illustrative purpose and by no means limiting. Instead, the scope of the invention is defined by the appended claims rather than by the description, and all variations that fall within the range of the claims are intended to be embraced therein. Thus, other embodiments than the specific ones described above are equally possible within the scope of these appended claims.

What is claimed is:

1. A method for promoting a platform based on user behavior analysis, characterized by comprising:
a promotion platform, which comprises a self-service factory sharing and planning module, a producing and making module, and a promotion information statistical module;
by means of the self-service factory sharing and planning module, a user applies for and obtains by self-service a personalized promotion code to become a promoter, the promoter shares the obtained personalized promotion code in the form of a hyperlink or a two-dimensional code with personalized icon on a third party network platform by means of a one-touch sharing module, the user enters the producing and making module of the promotion platform by clicking the hyperlink or scanning the two-dimensional code with personalized icon;
a promotion platform server monitors the user who has logged in the promotion platform, tracks and records behavior of the user who has logged in the promotion platform, makes statistics on the user behavior and the corresponding user behavior data, and presents the statistical result on the promotion information statistical platform.

2. The method of claim 1, characterized in that,
the promotion platform further comprises a user account management module,
upon detecting that the user who has logged in the promotion platform, the promotion platform server automatically tracks the path of the logged-in user to obtain the personalized promotion code which has been shared on the third party network platform, retrieves from the promotion platform server by using the obtained personalized promotion code the personal information of the promoter which is bound with the obtained personalized promotion code, collects the behavior of the user who has logged in the promotion platform from the same promoter and the corresponding user behavior data into the promotion information statistical platform of the promoter, converts and updates the obtained revenue into the account management module.

3. The method of claim 2, characterized in that,
the user behavior comprises when and where the user logs in the promotion platform and the operations the user makes in the promotion platform,
said operations comprise registering to enter the producing and making module, finishing the producing and making process of a product, entering the self-service factory sharing and planning module to apply for a personalized promotion code, and downloading any other personalized application,
if any of said operations is detected, the promotion platform server updates the user behavior data.

4. The method of claim 3, characterized in that,
the self-service factory sharing and planning module makes an statistical analysis on the user behavior, makes statistics on monthly amount of active users, amount of the personalized applications finished by users, and amount of news releases in the finished personalized application, which correspond to the personalized promotion code of the promoter, updates the statistical result into the promotion information platform, converts and updates the obtained revenue into the account management module.

5. The method of claim 4, characterized in that,
when the user applies for the personalized promotion code through the self-service factory sharing and planning module, the user firstly enters the account management module and inputs the user's personal information, and the promotion platform server automatically binds the user's personal information with the personalized promotion code.

6. The method of claim 5, characterized in that,
the personalized promotion code comprises the website of the promotion platform and the personal information of the promoter.

7. The method of claim 6, characterized in that,
the producing and making module is a personalized application making background in which the user makes the personalized application.

8. The method of claim 7, characterized in that,
the producing and making module tracks the origin of the user in the third party network platform who clicks the personalized promotion code to obtain the related information of the third party network platform, makes statistics and synchronously updates the statistical data into the promotion information module.

9. The method of claim 8, characterized in that,
the related information of the third party network platform comprises the name and website of the third party network platform and the amount of other users from the same third party network platform.

10. The method of claim 9, characterized in that,
the promotion information statistical module automatically ranks and presents the change in click rate of the promotion code of promoter from most to least.

11. The method of claim 10, characterized in that,
the promoter personal account is settled once per month at an appointed day.

12. The method of claim 11, characterized in that,
the promoter registers the promotion platform before applying for the personalized promotion code through the self-service factory sharing and planning module,
the promoter logs in the promotion platform and selects to make a personalized application,
upon finishing the personalized application, the promoter obtains a two-dimensional code with personalized icon,
the promoter shares the two-dimensional code with personalized icon in the third party network platform by one-touch sharing, and
the user scans the two-dimensional code with personalized icon and logs in the producing and making module to download the personalized application.

13. The method of claim 12, characterized in that,
after the user scans the two-dimensional code with personalized icon corresponding to the personalized application and logs in the promotion platform, the promotion platform server tracks the path of the user who scans the two-dimensional code with personalized icon and logs in the promotion platform, so as to obtain the two-dimensional code with personalized icon,
the promotion platform server retrieves the personal information of the promoter who has made the personalized application by using the obtained two-dimensional code with personalized icon, makes statistics on the amount of users who log in the producing and making module and the amount of users who succeed in downloading the personalized application, respectively, and updates the statistical amount of users into the corresponding promoter personal account.

14. The method of claim 13, characterized in that,
the personalized icon the two-dimensional code with personalized icon is a text with different fonts or a picture.
